(19) United States
(12) Patent Application Publication
(10) Pub. No.: US 2005/0206827 A1
(43) Pub. Date: Sep. 22, 2005

(54) Image display device

(76) Inventor: Shih-Hsien Tseng, Hsin-Chu (TW)

Correspondence Address: CROWELL & MORING LLP;INTELLECTUAL PROPERTY GROUP, P.O. BOX 14300, WASHINGTON, DC, 20044-4300, US

(21) Appl. No.: 11/063,888

(22) Filed: Feb. 23, 2005

(30) Foreign Application Priority Data
Feb. 23, 2004 (TW) 093104494

(51) Int. Cl. G02F 1/1345; H01J 29/10

(52) U.S. Cl. 349/149; 313/463

(57) ABSTRACT

An image display device capable of being produced with reduced manufacturing cost, and improved product performance. The image display device comprises: an LCD module, conjoint substrate, at least one driving circuit and a plurality of contacts, wherein the LCD module includes at least one liquid crystal layer and one transparent electrode, for displaying images in accompaniment with the a plurality of electrodes provided on the upper surface of the conjoint substrate, each pixel electrode being connected to a predetermined location at a lower surface of the conjoint substrate through at least one conductive route and then to driving transistors provided in the driving circuit through the contacts, so as to preserve the superior performance of active matrix displays while improving the production yield and reducing the manufacturing cost of the final products. Also disclosed are process of making and using and products comprising the image display device.

### BACKGROUND OF THE PRESENT INVENTION

1. Field of the Invention

This invention relates to an image display device, particularly to one capable of reducing manufacturing cost, and improving product performance. The image display device uses a conjoint substrate electrically connecting switching transistors of a driving circuit and a Liquid Crystal Display (LCD) or Organic Light Emitting Display (OLED) module, so as to preserve the superior performance of active matrix displays while improving the production yield and reducing the manufacturing cost of the final products.

2. Brief Description of the Related Art

Recently, to meet the various demands of the computer commercial market, the image display industry has invested significant amount of efforts in developing new products. Due to the high potentiality of reduced weight, and thickness profile, and power consumption, the variety of products that have been developed by the image display industry has also gained consumers' great attention.

FIG. 1 is a cross-sectional view illustrating the structure of a conventional TFT LCD panel, comprising: a glass substrate 10, a plurality of thin film transistors 14 and storage capacitors 15 formed thereover; a inter-layer insulating film 11 deposited over the thin film transistors 14 and storage capacitors 15, and a plurality of pixel electrodes 12 formed thereover, each pixel electrode 12 being electrically connected to the respective thin film transistor 14 and storage capacitor 15 through a contact hole 113; and a liquid crystal layer 13, a transparent electrode 123 and a transparent substrate 17 sequentially deposited over the pixel electrode 12.

As shown by the planar schematic view of the pixel structure illustrated in FIG. 1B, it is known that sources 143 of thin film transistors are connected to the longitudinally extending data line 16, the gate 141 to horizontally extending gate line (scanning line) 18, and drain 145 to the storage capacitor 15 and pixel electrode 12. The data line 16 and gate line 18 intersects each other to form pixel areas. Except for the range covered by the thin film transistor 14, each pixel electrode 12 substantially covers the respective pixel area in entirety for displaying images in accompaniment with the liquid crystal layer and transparent electrode.

The above structure, upon incorporation of a back light module and other optical thin films, features the image display device with a wide viewing angle, high luminance and fast response time, while facilitating manufacturing of a large-scale image display device.

The process for forming a matrix circuitry of thin film transistors over a glass substrate is similar to the manufacturing of semiconductor ICs, both with complicated manufacturing procedures and requiring investment in costly image display manufacturing equipment. However, the driving current and other electrical characteristics of amorphous silicon thin film transistors are not inferior to those of transistors made from semiconductor manufacturing process, monocrystalline manufacturing process, or polycrystalline manufacturing process. In addition, in accordance with the above structure, the area occupied by the thin film transistor in each pixel area is incapable of displaying thereby reducing the overall performance of the image display device.

### SUMMARY OF THE INVENTION

In view of the above, it is a primary objective of this invention to provide an image display device having an conjoint substrate electrically connecting a switching transistors of driving circuit and an LCD module, wherein the switching transistors of driving circuit and LCD module of the image display device may be independently manufactured prior to assembly so as to improve the production yield and reliability of the products significantly.

It is another objective of this invention to provide an image display device, where the process of manufacturing the liquid crystal module is independent from the semiconductor manufacturing process for manufacturing the switching transistors of driving chip so as to reduce the manufacturing cost significantly.

It is a further objective of this invention to provide an image display device, wherein the pixel electrode and switching transistors are discretely formed and electrically connected by conductive circuits, so as to preserve the advantages provided by active matrix displays while increasing the effective display area at the same time.

It is another objective of this invention to provide an image display device, where the conjoint substrate and conductive circuits may be made of a transparent material, and the conjoint substrate is provided thereunder with a diffusive surface capable of guiding light and serving as a back light module upon incorporation with an illuminant device.

It is another objective of this invention to provide an image display device, where the conjoint substrate and conductive circuits are made of a flexible material so as to obtain a flexible display panel.

It is a further objective of this invention to provide an image display device, where the conductive circuits may form a patterned circuit for electrically connecting the pixel electrodes to predetermined locations of a lower surface of the conjoint substrate and then electrically connecting to the switching transistors of driving chip, to facilitate the manufacturing of large-scale panels.

It is another objective of this invention to provide an image display device, where the image display device may be implemented in Organic Light Emitting Display (OLED) devices so as to simplify the manufacturing process and improve the production yield of the products.

### BRIEF DESCRIPTION OF THE DRAWINGS

These and other modifications and advantages will become apparent from the following detailed description of a preferred embodiment of the invention and from the drawings in which:

FIG. 1A illustrate a partial cross-sectional view of conventional TFT LCD panel;

FIG. 1B is a planar schematic view illustrating a pixel of a conventional TFT LCD panel;

FIG. 2 is a partial cross-sectional view of a preferred embodiment of this invention;

FIG. 3 is a partial cross-sectional view of a conjoint substrate of this invention;

FIG. 4 is a partial cross-sectional view of the switching transistors of driving chip illustrated in the embodiment of FIG. 2;

FIG. 5 is a partial cross-sectional view of an alternative embodiment of the conjoint substrate of this invention;

FIG. 6 is a partial cross-sectional view of another preferred embodiment of this invention; and

FIGS. 7A and 7B are schematic views illustrating different circuits embodied in the embodiment of FIG. 6.

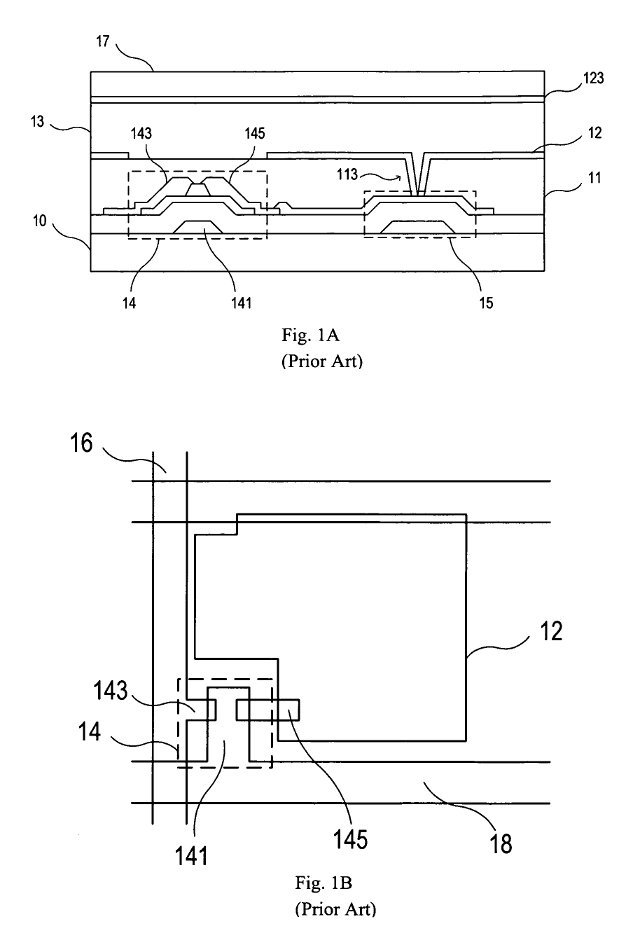

### DETAILED DESCRIPTION OF THE PREFERRED EMBODIMENTS

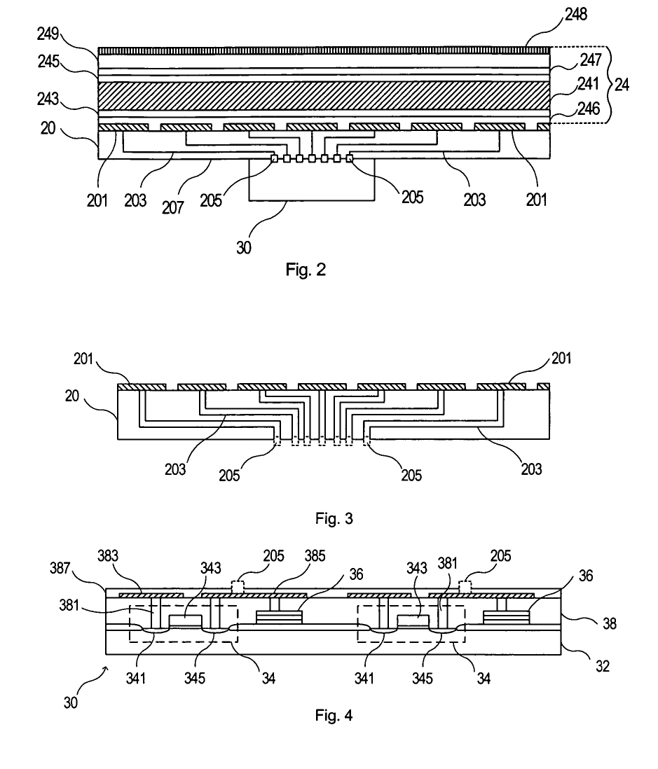

FIGS. 2 to 4 illustrate the partial cross-sectional views of a preferred embodiment, a conjoint substrate and a switching transistors of driving chip according to this invention. As shown, this invention includes: an LCD module 24, a conjoint substrate 20 and a switching transistors of driving circuit 30, wherein the conjoint substrate 20 is provided on an upper surface thereof with a plurality of pixel electrodes 201. The pixel electrodes 201 are sequentially deposited thereover with a passivation layer 246, a first alignment film 243, a liquid crystal layer 241, a second alignment film 245, a transparent electrode 247, a transparent substrate 249 and a polarizer layer 248, thereby constructing an LCD module 24. The conjoint substrate 20 is provided therein with a plurality of conductive circuits 203 for electrically connecting the pixel electrode 201 to the predetermined location of a lower surface of a conjoint substrate. The conjoint substrate 20 may be made by a semiconductor manufacturing process, by forming the conductive circuits 203 within the substrate, thereby the terminals exposing out of a lower surface 207 of the conjoint substrate thereby serving as the conductive terminals 205.

The switching transistors of driving circuit may be integrated into a driving chip 30 by using the semiconductor manufacturing process. First, a plurality of switching transistors 34 and storage capacitors 36 is formed on silicon substrate 32 and then deposited thereover with an insulating layer 38. The insulating layer 38 is provided with conductive wires made of a conductive material (such as metal) in the form of metal lines 383 and 385. Each metal line is respectively connected to the drain 341, source 345 and storage capacitor 36 of the driving transistor 34 through an individual contact hole 381. The metal lines may be deposited thereover with an insulating layer 387, such that an opening is predetermined over the metal line for allowing electrical connection with the conductive terminals 205. The metal lines 383 connecting to the drain 341 are in fact data lines, and gates 343 are connected to the respective gate lines (not shown). In the above driving circuit, the switching transistors 34 may be provided to drive the pixel electrodes 201 without the predesigned storage capacitors, which is an alternative embodiment of the LCD device.

Each set of switching transistor 34 and storage capacitor 36 is electrically connected to the respective pixel electrode 201 through the metal lines 385, conductive terminals 205 and conductive circuits 203, thereby constructing an active matrix switching pixel electrode array. By incorporating the LCD module 24 and the driving circuit of the data lines and gate lines with other optical modules (such as a back light module or other optical thin film), this invention ensures superior display performance with a wide viewing angle, high luminance and fast response time.

In the above structure, a high performance reflective LCD device is obtained by using a light reflective material (such as a metal) to form the pixel electrodes 201. Furthermore, a transmissive LCD device is obtained, by using a transparent conductive material for forming the pixel electrodes 201 and conductive circuits, and using a transparent material for forming the conjoint substrate 20, and the lower surface 207 of the conjoint substrate predesigned into a diffusive surface matching with illuminant as through a light guide, using optical films or metal sputtering or other surface treatment techniques.

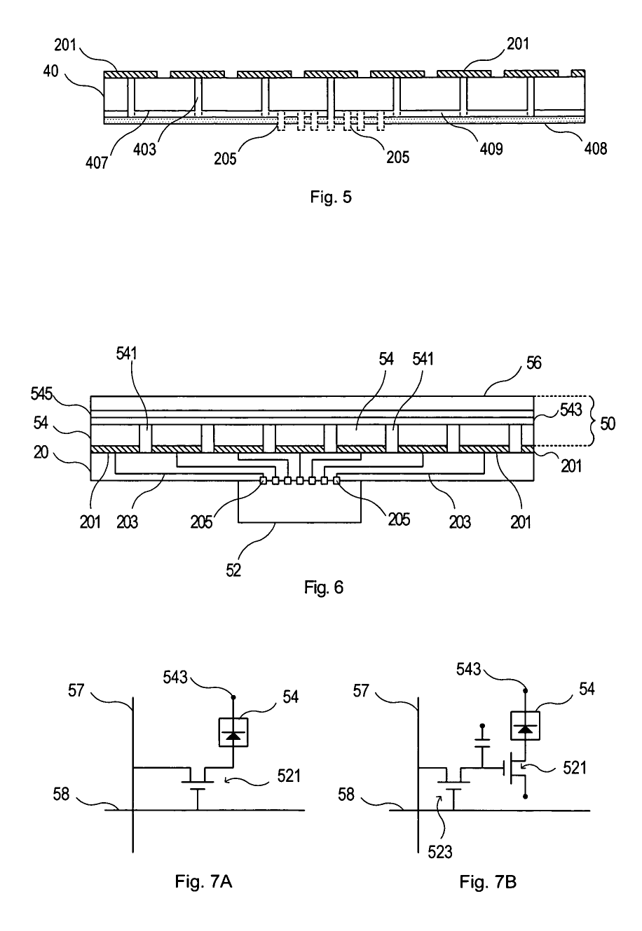

FIG. 5 illustrates a partial cross-sectional view of another embodiment of the conjoint substrate of this invention. As shown, an opening hole is formed on the predetermined positions of each pixel electrode 201 within a conjoint substrate 30. The opening hole is then filled with a conductive material to become conductive circuits 403, thereby a patterned circuit 409 is formed at a lower surface 407 of the conjoint substrate. The conductive circuits 403 are electrically connected to predetermined locations of the lower surface 407 of the conjoint substrate and then electrically connecting with the respective conductive terminals 205. In addition, a passivation layer 408 may be provided to cover the patterned circuit 409 serving as a protective shield.

In addition, the conjoint substrate of this invention can be manufactured with a flexible material, while the conductive circuits can be manufactured with a conductive polymer, a transparent conductive material (such as ITO) or a metal, to facilitate the manufacturing of flexible display panels. In each embodiment, the conductive terminals 205 are formed by exposing the terminals of the conductive circuits from the predetermined locations of the lower surface of the conjoint substrate, or by forming a stud of metal lines 205, therein extruding from the top surface of driving chip, for electrically connecting the sources electrode 345 of the switching transistors 34 and storage capacitors 36.

In the driving circuit 30 of this invention, other than the switching transistors 34 of driving circuit and storage capacitors 36, the circuit may also include a scanning circuit for driving the gate lines, a data driving circuit for driving the data lines, a digital signal processor, a microprocessor, a memory, and other control circuits (not shown) that are integrated into a single chip so as to improve the display performance and reduce the manufacturing cost. Using the conductive circuits as an electrical connection interface, the switching transistors of driving circuits and storage capacitors of a driving chip of a relatively smaller size can be electrically connected to the pixel electrodes of a lage-scale conjoint substrate, thereby facilitating the manufacturing of large scale display panels.

With reference to FIGS. 6, 7A and 7B, where FIG. 6 is a partial cross-sectional view of another preferred embodiment of this invention; and FIGS. 7A and 7B are schematic views illustrating different circuits embodied in the embodiment of FIG. 6. Accordingly, the structure of this invention may also be implemented in the manufacturing of organic light emitting diode (OLED) image display devices. As shown, the device includes: an organic light emitting module 50, a conjoint substrate 20 and a switching transistors of driving circuit, wherein the organic light emitting module 50 is provided with organic pixels formed on the respective pixel electrodes 201 and having an electron transport layer, a light-emitting layer and a hole transport layer. The organic pixels 54 are isolated from each other by means of an insulator 541. The image display device is further provided with a transparent electrode 543 connecting to an upper surface of each organic pixel 54 and covered by a passivation layer 545. The top most layer of the image display device is a transparent substrate 56. The conjoint substrate can be e.g., the structure as shown in FIG. 3 or FIG. 5. The driving circuit can be integrated into a driving chip 52 by using the conventional semiconductor manufacturing process. The driving chip is provided with a plurality of switching transistors 521, thereby electrically connected to an upper surface of each of the driving chip 52 by a conductive material (metals, not shown), and then electrically connected to pixel electrodes 201 through the respective conductive terminals 205 and conductive circuits 203.

Similarly, the conjoint substrate of this invention can be formed from a flexible material, and the conductive circuits can be formed from a conductive polymer, a transparent conductive material (such as ITO), or a metal material, to facilitate the manufacturing of flexible display panels. The conductive terminals 205 are formed by exposing the terminals of the conductive circuits from the predetermined locations of the lower surface of the conjoint substrate 20, or by forming a stud of a metal lines, therein extruding from the top surface of driving chip 52, for electrically connecting with the sources electrode of the switching transistors 34.

In the driving circuit 52 of this invention, other than the switching transistors 521, each of the switching transistors can also be connected to at least one transistor 523 and one capacitor 525 to serve as different driving means of the organic pixels 54, to provide gate voltage stored in the switching transistors, to stabilize current passing through the organic pixels 54, to enhance the image, and to reduce the response time, so as to improve the display performance of the organic light emitting diode (OLED) image display devices.

In addition, the driving chip 52 may also include a scanning circuit for driving the gate lines 58, a data driving circuit for driving the data lines 57, a digital signal processor, a microprocessor, a memory, and other control circuits (not shown) that are integrated into a single chip so as to improve the display performance and reduce the manufacturing cost. Using the conductive circuits as an electrical connection interface, therein the switching transistors of driving circuits and storage capacitors of a driving chip, compared smaller size than the conjoint substrate, are electrically connected to the pixel electrodes of the lage-scale conjoint substrate to facilitate the manufacturing of large scale display panels.

According to the disclosure of this invention, the pixel electrodes and switching transistors of driving circuits are designed to be manufactured independently so as to maximize the overall area of the pixel electrodes, to increase the effective light-emitting area, and to improve the display performance, while the independent switching transistors of driving circuit can be manufactured by mature semiconductor process procedures, monocrystalline process procedures or polycrystalline process procedures, so as to preserve the superior performance of active matrix image displays device while improving the production yield and reducing the manufacturing cost of the products.

In summary, this invention relates to an image display device capable of reducing manufacturing cost, and improving product performance. This invention employs a conjoint substrate electrically connecting a switching transistor of driving circuit and an LCD module or OLED module, so as to preserve the superior performance of active matrix displays while improving the production yield and reducing the manufacturing cost of the final products.

This invention is related to a novel creation that makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

1. An image display device, comprising:
a LCD module, having at least a liquid crystal layer and a transparent electrode;
a conjoint substrate, having a plurality of pixel electrodes on an upper surface thereof in accompaniment with the LCD module for displaying images, each pixel electrode being connected to a predetermined location of a lower surface of the conjoint substrate through a conductive circuit;
at least a driving circuit, having a plurality of switching transistors, each switching transistor being connected to an upper surface of the driving circuit through a conductive material; and
a plurality of conductive terminals, provided on the predetermined locations between the lower surface of the conjoint substrate and the conductive material at the upper surface of the driving circuit, for electrically connecting the switching transistors to the respective pixel electrodes through the respective conductive circuits.

2. The image display device of claim 1, wherein the driving circuit further comprises a plurality of storage capacitors that are connected to the respective switching transistors.

3. The image display device of claim 1, wherein the conjoint substrate and the conductive circuits are manufactured with conventional semiconductor manufacturing process.

4. The image display device of claim 1, wherein the conductive circuits are connected from the pixels electrode down to the lower surface of the conjoint substrate and then to a patterned circuit at the lower surface of the conjoint substrate for electrically connecting to the conductive terminals formed at the predetermined locations of the lower surface.

5. The image display device of claim 4, wherein the patterned circuit is covered by a passivation layer.

6. The image display device of claim 1, wherein the conjoint substrate is manufactured with a flexible material.

7. The image display device of claim 6, wherein the conductive circuits in the conjoint substrate are formed of a conductive polymer, a transparent conductive material, a metal or a combination thereof.

8. The image display device of claim 1, wherein the conjoint substrate is formed of a transparent material and the lower surface of the conjoint substrate is a diffusive surface allowing light to be evenly diffused upward.

9. The image display device of claim 8, wherein the pixel electrodes on the conjoint substrate are made of a transparent conductive material.

10. The image display device of claim 1, wherein the driving circuit is formed using a conventional semiconductor manufacturing process, a monocrystalline manufacturing process, or a polycrystalline manufacturing process.

11. The image display device of claim 10, wherein the driving circuit comprises: a scanning driving circuit, a data driving circuit, a digital signal processor, a microprocessor, or a memory, or a combination thereof.

12. The image display device of claim 1, wherein the conductive terminal is formed of an extruding stud from the conductive circuits and the conductive material provided at the upper surface of the driving circuit.

13. The image display device of claim 1, wherein the conjoint substrate has an area greater than an area of the driving circuit.

14. A image display device, comprising:
a conjoint substrate, having a plurality of pixel electrodes on an upper surface thereof, each pixel electrode being individually connected to a predetermined location at a lower surface of the conjoint substrate through a conductive circuit;
an organic light emitting module, having a plurality of organic light emitting pixels and a transparent electrode, wherein the organic light emitting pixels are formed over the respective pixel electrodes and each comprises an electron transport layer, a light-emitting layer and a hole transport layer, for displaying images in accompaniment with the pixel electrodes;
at least a driving circuit, having a plurality of switching transistors, each switching transistor being electrically connected to the upper surface of the driving circuit through a conductive material; and
a plurality of conductive terminals, provided on predetermined locations between the lower surface of the conjoint substrate and the conductive material at the upper surface of the driving circuit, for electrically connecting the switching transistors to the respective pixel electrodes through the respective conductive circuits.

15. The image display device of claim 14, wherein the conductive circuits are embedded in the conjoint substrate.

16. (canceled)

17. The image display device of claim 14, wherein the conductive circuits are connected from the pixels electrode down to the lower surface of the conjoint substrate and then to a patterned circuit at the lower surface of the conjoint substrate for electrically connecting to the conductive terminals formed at the predetermined locations of the lower surface.

18. The image display device of claim 17, wherein the patterned circuit is covered by a passivation layer.

19. The image display device of claim 14, wherein the conjoint substrate is manufactured with a flexible material.

20. The image display device of claim 19, wherein the conductive circuits in the conjoint substrate are formed of a conductive polymer, a transparent conductive material, a metal, or a combination thereof.

21. The image display device of claim 14, wherein the pixel electrodes are formed of a metal material.

22. (canceled)

23. The image display device of claim 14, wherein the switching transistors in the driving circuit are connected to at least one transistor and at least one capacitor for enhancing the performance of the image display device.

24. (canceled)

25. (canceled)

26. (canceled)
